(19) United States
(12) Patent Application Publication
(10) Pub. No.: US 2007/0003080 A1
(43) Pub. Date: Jan. 4, 2007

(54) Speaker apparatus

(75) Inventors: Koji Takayama, Yamagata (JP); Hiroyuki Kobayashi, Yamagata (JP)

Correspondence Address: DRINKER BIDDLE & REATH (DC), 1500 K STREET, N.W., SUITE 1100, WASHINGTON, DC, 20005-1209, US

(73) Assignees: PIONEER CORPORATION; TOHOKU PIONEER CORPORATION

(21) Appl. No.: 11/436,997

(22) Filed: May 19, 2006

(30) Foreign Application Priority Data
May 20, 2005 (JP) P2005-148224

(51) Int. Cl. H04R 25/00

(52) U.S. Cl. 381/150

(57) ABSTRACT

A speaker apparatus includes: a frame that has a diaphragm at a front side thereof; and a magnetic circuit that is disposed at a rear side of the frame so as to drive the diaphragm. The magnetic circuit includes a magnet having a polygonal outer profile coaxially positioned with the diaphragm.

The present disclosure relates to the subject matter contained in Japanese Patent Application No. 2005-148224 filed May 20, 2005, which is incorporated herein by reference in its entirety.

### BACKGROUND OF THE INVENTION

### Field of the Invention

The present invention relates to a speaker apparatus that includes a frame in which a diaphragm is mounted at a front side and a magnetic circuit received at a rear side of the frame to drive the diaphragm.

In recent years, as a theater system becomes commonly used, a high-power capability in a speaker becomes regarded as an important factor.

In the high-power capability in a speaker, strengthening a magnet for a magnetic circuit results in an increase of a driving force for a diaphragm. A structure for fixing the magnetic circuit is required, which has solidity enough to withstand a reacting force as much as the increase of the driving force.

A structure in which a magnetic circuit is interposed between the rear side of a frame and a locking portion mounted in the frame has been proposed as a structure for fixing a magnetic circuit, which is designed to withstand a reacting force corresponding to a driving force of the magnetic circuit (For example, see JP-A-2004-187232).

### SUMMARY OF THE INVENTION

In the structure for fixing a magnetic circuit, when locking portion mounted inside a frame is axially displaced forward due to an axial dimensional error of the magnetic circuit and functions as a damper holder formed of a damper-fixing portion as disclosed in JP-A-2004-187232, this affects on the position of the damper. As a result, the accuracy in assembly of a voice coil bobbin which is held inside the frame by the damper becomes poor.

Accordingly, as a speaker having the same or more strength than the structure in JP-A-2004-187232, the inventors conceived a speaker including a frame that has a diaphragm at the front side thereof, a magnetic circuit that is disposed at the rear side of the frame to drive the diaphragm, a locking wall that protrudes inside the frame to press the front end of the magnetic circuit, and a rear cover that is screw-engaged to the rear end of the frame to press the rear end of the magnetic circuit. In addition, the inventors designed such that the magnetic circuit is interposed between the rear cover and the locking wall.

A speaker is required to be reduced in size when it is too big to be disposed in a desired space. In particular, as for a speaker for a vehicle, small-sizing is an important factor because a space is not enough for installation due to installation positions disposed inside a door.

However, in the above-mentioned structure for fixing a magnetic circuit to the rear side of a frame by screws, it is required to increase the thickness of a circumferential wall at the rear side of the frame, which encloses the circumference of a magnetic circuit, in order to fasten a rear cover using screws. Because a magnet for a magnetic circuit has a circular outer profile, when the circumferential wall at the rear side of the frame is increased without increasing the outer diameter of the rear side, a magnet received inside the magnet is required to be decreased in diameter. As a result, a driving force decreases due to the small-sized magnet.

Further, as for the structure for fixing a magnetic circuit disclosed in JP-A-2004-187232, because a magnet has to be mounted such that it does not interfere an arm, a magnet to be mounted inside the frame is also limited in the outer diameter. Therefore, a driving force decreases due to the small-sized magnet as in the above-mentioned structure having a rear cover fastened by screws.

It is an object to provide a structure allowing an increased driving force for a diaphragm and fixing a magnetic circuit withstanding a reaction due to the driving force in order to obtain a high-power capability in a small-sized speaker.

The invention provides a speaker apparatus including a frame that has a diaphragm at a front side thereof; and a magnetic circuit that is disposed at a rear side of the frame so as to drive the diaphragm. The magnetic circuit includes a magnet having a polygonal outer profile coaxially positioned with the diaphragm.

### BRIEF DESCRIPTION OF THE DRAWINGS

The present invention may be more readily described with reference to the accompanying drawings:

FIG. 1 is a rear view showing a speaker of a first embodiment according to the invention.

FIG. 2 is a cross-sectional view taken along line II-II in FIG. 1.

FIG. 3 illustrates an embodiment of a magnet having a triangular outer profile in the speaker of the first embodiment according to the invention.

FIG. 4 illustrates an embodiment of a magnet having a rectangular outer profile in the first embodiment according to the invention.

FIG. 5 illustrates an embodiment of a magnet having a pentagonal outer profile in the first embodiment according to the invention.

FIG. 6 illustrates an embodiment of a magnet having an octagonal outer profile in the first embodiment according to the invention.

FIG. 7 is a rear view showing a speaker of a second embodiment according to the invention.

FIG. 8 is a cross-sectional view taken along line VIII-VIII in FIG. 7.

### DETAILED DESCRIPTION OF THE PREFERRED EMBODIMENTS

A speaker according to the present invention includes a frame having a diaphragm at the front side and a magnetic circuit disposed at the rear side of the frame to drive the diaphragm. A magnet in the magnetic circuit has a polygonal outer profile coaxially positioned with the diaphragm.

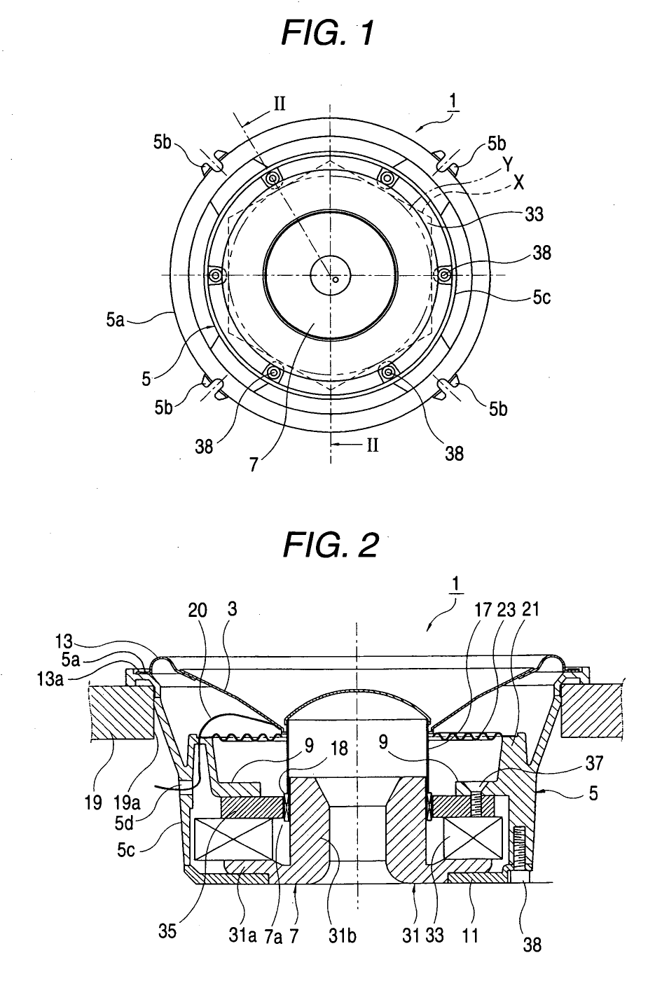

Below, a first embodiment of a speaker according to the invention will be described in reference to accompanying drawings in detail. FIG. 1 is a rear view of a speaker of the first embodiment according to the invention. FIG. 2 is a cross-sectional view taken along line II-II in FIG. 1.

The speaker 1 according to the first embodiment includes a frame 5 having a diaphragm 3 at the front side, a magnetic circuit 7 disposed at the rear side of the frame 5 to drive the diaphragm 3, a locking wall 9 protruding inside the frame 5 to fix the front end of the magnetic circuit 7, and a rear cover 11 screw-engaged to the rear side of the frame 5 to fix the rear end of the magnetic circuit 7. The magnetic circuit 7 is interposed between the rear cover 11 and the locking wall 9.

The diaphragm 3 has a cone shape, and an edge damper 13 adheres to the periphery of the diaphragm 3, of which a rim 13a is fixed to an edge-supporting portion 5a at the front of the frame 5. In other words, the rim of the diaphragm 3 is attached to the front side of the frame 5 through the edge damper 13. A cylindrical voice coil bobbin 17 adheres to the inside of the diaphragm 3 and a voice coil 18 is wound around the voice coil bobbin 17.

Claw portions 5b, which are connecting portions connected to a baffle 19 of a cabinet by a threaded fastening, are provided on the rear face of the edge-supporting portion 5a of the frame 5 and radially protrude out of the edge-supporting portion 5a.

The frame 5 is a casting of aluminum or an aluminum alloy and the locking wall 9 is integrally formed at the middle of a substantially cylindrical circumferential wall 5c which is inserted in an opening 19a of the baffle 19.

A lead wire-through hole 5d through which a lead wire 20 is led from the voice coil 18 is formed through the circumferential wall 5c.

A damper-supporting portion 21 is integrally formed with the locking wall 9 on the front face. The damper-supporting portion 21 is a cylindrical part extending toward the front side of the frame and the rim of a corrugation damper 23 is fixed to the front face.

The inside circumference of the corrugation damper 23 adheres to the voice coil bobbin 17, which supports the bobbin to vibrate rear and forth.

The magnetic circuit 7 includes a yoke 31 configured such that a center pole 31b protrudes at the center of a disc-shaped plate 31a, a ring-shaped magnet 33 held around the circumference of the center pole 31b, and a ring-shaped top plate 35 provided close to the end of the center pole 31b such that the magnet 33 is interposed between the top plate 35 and the plate 31a.

A gap between the inside of the top plate 35 and the center pole 31b is a magnetic gap 7a where the voice coil 18 is disposed.

Being in contact with the bottom of the locking wall 9, the top plate 35 is fixed to the locking wall 9 by screws 37 inserted in the locking wall 9.

The yoke 31 is pressed and fixed by the rear cover 11 pressing the plate 31a toward the locking wall 9. The rear cover 11 is fixed at the rear side of the frame 5 by screws 38 threaded-fastened to the circumferential wall Sc.

In the present embodiment, the magnet 33 shown with a dashed line X in FIG. 1 has a hexagonal outer profile coaxially positioned with the diaphragm about the central axis I. Positions for fastening the rear cover 11 to the circumferential wall 5c of the frame 5 are arranged outside the magnet 33, near the middle of each side.

In the speaker 1 described above, the magnetic circuit 7 at the rear side of the frame 5 is interposed between the locking wall 9 protruding inside the frame 5 and the rear cover 11 screw-engaged to the rear side of the frame 5. According to this configuration, the securing strength which is capable of withstanding a reacting force corresponding to the driving force of the magnetic circuit 7 is achieved

Because the rear cover 11 pressing the rear end of the magnet circuit 7 is connected to the frame 5 by screws, an axial dimensional error of the magnetic circuit 7 causes the rear cover 11 to be connected to the frame at a further rear position than the desired position and the magnetic circuit 7 to protrude out of the frame 5. Accordingly, other parts provided in the front of the magnetic circuit 7, such as the corrugation damper 23 and the voice coil bobbin 17, is not affected in position.

The magnet 33 for the magnetic circuit 7 has a hexagonal outer profile X1 (drawn with a dotted line) and the threaded fastening position the rear cover 11 to the frame 5 is arranged outside the magnet 33, near the middle of each side. Therefore, compared to a magnet (two-dot chain line) having a circular outer profile so as not to interfere the threaded fastening position, the volume of the magnet 33 increases as much as the angular parts of the hexagon out of its inscribed circle Y1, thus the driving force may increase as magnetic flux increases resulting from the increase of the magnet 33 in size.

Accordingly, the driving force may be increased without increasing the outer diameter of the frame 5 and decreasing the magnet 33 in size, and the speaker 1, which is ideal for a vehicle requiring a compact one having large driving force, is achieved.

According to the estimation by the inventor, compared to a magnet having an outer profile of the inscribed circle Y1, the magnet having the hexagonal outer profile increases about 16% in volume, thus achieves improved magnetic flux.

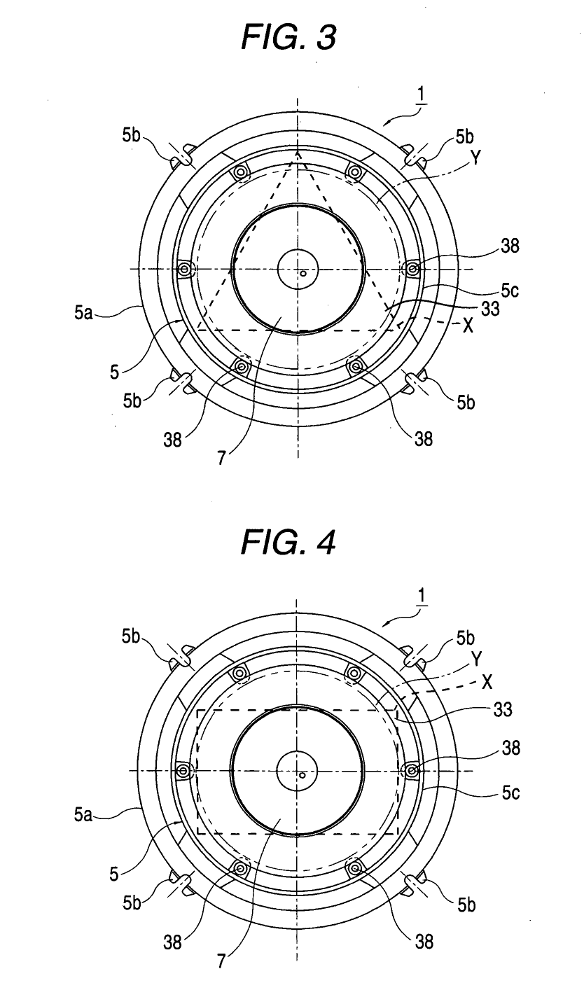

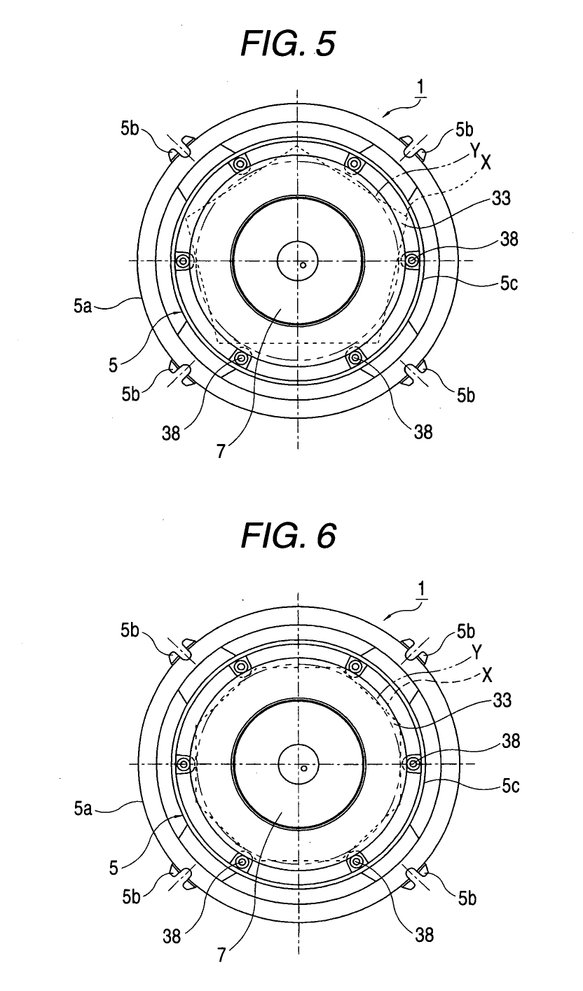

The outer profile of the magnet is not limited to the hexagon as described in the above embodiment, and, for example, may be any polygon such as a triangle, rectangle, pentagon, or octagon. A variety of embodiments for magnets having triangular, rectangular, pentagonal, and octagonal outer profiles are illustrated in FIGS. 3, 4, 5, and 6, respectively.

However, as the outer profile of the magnet becomes polygonalized, the structure becomes more complicated and the space at the outside of each side for threaded fastening is also decreased. Accordingly, smaller screws are needed for the threaded fastening. As shown in FIG. 1, however, as for the hexagon, the structure of the magnet 33 is not too complicated and it is easily manufactured.

Further, in the magnet having hexagonal outer profile, the space at the outside of each of the sides is not too much decreased and screws for the threaded fastening are not needed to be too small. Therefore, desired strength for fixing the magnet may be easily achieved by using screws having enough size for the strength.

In other words, it is possible to keep the balance between the productivity of the magnet 33 and the threaded fastening strength.

A second preferred embodiment will be described below.

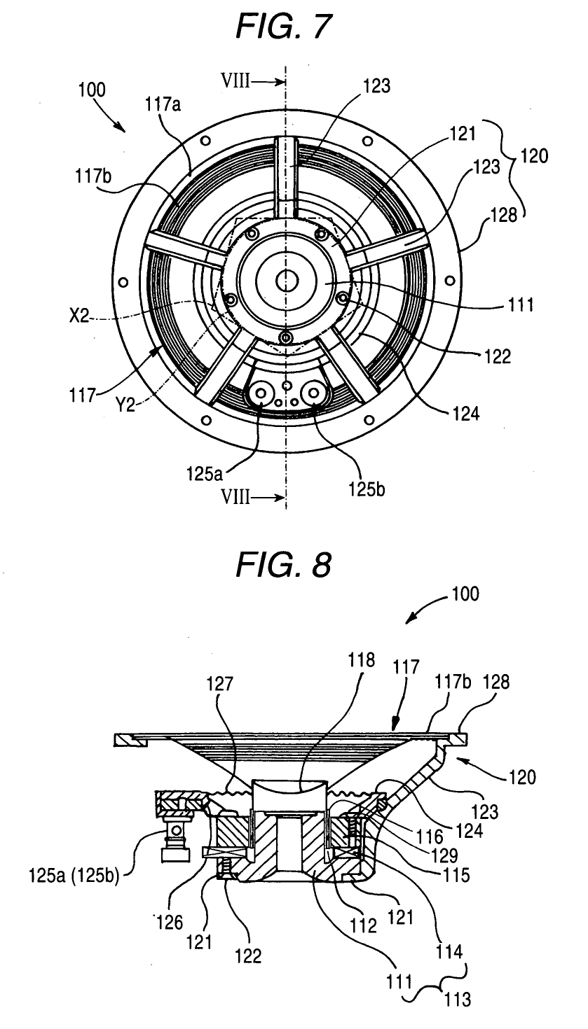

FIG. 7 shows a rear view of a speaker of a second embodiment according to the invention and FIG. 8 is a cross-sectional view taken along line VIII-VIII in FIG. 7.

A speaker 100 according the second embodiment has a yoke 111 at the center. A magnetic gap 112 is defined outside the yoke 111, where a magnet 114 and a top plate 115 consisting of a magnetic circuit 113 are provided.

A voice coil 116 is disposed in the magnetic gap 112 and capable of moving front and back, and also mounted around a central hole of a substantially cone-shaped diaphragm 117. A cap 118 is mounted at the front of the central hole of the diaphragm.

A circular mounting surface 121 consisting of a frame 120 as a case is mounted on the rear side of the yoke 111 by screws 122. A plurality of arms 123 (five arms in this embodiment) around the yoke 111 and the magnet 114 including the mounting surface 121 are provided, increasing in radius toward the front side when seen from the side.

A terminal supporting ring 124 is mounted at a predetermined position of the arm 123 and a pair of speaker terminals 125a, 125b for positive or negative polarities is mounted around the periphery, under the terminal supporting ring 124. The voice coil 116 is electrically connected to the positive and negative speaker terminals 125a, 125b through tinsel wires 126, 126. Further, the lower portion under the inner circumference of the terminal supporting ring 124 is fixed to the upper face of the top plate 115 by screws 129.

In other words, the magnetic circuit is interposed between the rear side of the frame (the mounting surface 121) and a locking portion (the terminal supporting ring 124) mounted inside of the frame.

A damper 127 is provided between the terminal supporting ring 124 and the diaphragm 117 and the voice coil 116 is supported in the magnetic gap 112 to be exactly positioned. The damper 127 has elasticity to deform as the voice coil 116 moves front and back. A ring 128 is integrally formed with the arms 123 along the front ends and circumference 117a of the edge 117b of the diaphragm 117 is connected with the ring 128.

The outer profile of the magnet 114 for the magnetic circuit 113 is a pentagon X2 (drawn with one-dot chain line in FIG. 7) and the arms 123 are positioned outside the magnet 114, at the almost middle of the sides of the pentagon X2. Compared to a magnet having a circular outer profile so as not to interfere the arms 123, the volume of the magnet 114 increases as much as the angular parts of the pentagon (drawn with one-dot chain line) out of its inscribed circle Y2. Accordingly, the driving force may increase as magnetic flux increases resulting from the increase of the magnet 114 in size.

Accordingly, the driving force may be increased without increasing the outer diameter of the frame 120 and decreasing the magnet 114 in size, and the speaker 100 which is ideal for a vehicle requiring a compact one having large driving force is achieved

The outer profile of the magnet is not limited to a pentagon as in the second embodiment, and, for example, may be any polygon such as a triangle, rectangle, hexagon, or octagon depending on the number of the arms 123.

As described above, it is preferable to determine the outer profile of the magnet 114 depending on the number of the arms 123. However, as the outer profile of the magnet 114 becomes more polygonalized, the structure becomes more complicated and the manufacturing is more difficult. As the magnet becomes polygonal, a volume difference between the magnets having a polygonal outer profile and a circular outer profile becomes smaller. As a result, it is not preferable. Considering the strength of the whole frame, the tone quality of the speaker, and easy manufacturing, the optimum number of the arms 123 is about five (five arms 123 in the embodiments shown in FIGS. 7 and 8). Therefore, the magnet having a pentagonal outer profile has greatest effect in the increase of volume.

As described above, the speaker of each embodiment according to the invention includes a frame having a diaphragm at the front side and a magnetic circuit disposed at the rear side of the frame to drive the diaphragm. A magnet in the magnetic circuit has a polygonal outer profile coaxially positioned with the diaphragm.

The speaker in the first embodiment includes a locking wall protruding inside the frame to press the front end of a magnetic circuit and a rear cover screw-engaged to the rear side of a frame to press the rear end of the magnetic circuit. The magnetic circuit is interposed between the rear cover and the locking wall. Each position for threaded fastening is arranged outside the magnet having the polygonal outer profile, near the middle of each side.

Accordingly, the magnetic circuit 7 at the rear side of the frame 5 is interposed between the locking wall 9 protruding inside the frame and the rear cover 11 screw-engaged to the rear side of the frame. Therefore, the securing strength which is enough to prevent a reacting force corresponding to the driving force of the magnetic circuit 7 can be achieved.

Further, because the rear cover 11 pressing the rear end of the magnet circuit 7 is connected to the frame by screws, an axial dimensional error of the magnetic circuit 7 causes the rear cover 11 to be connected to the frame at a further rear position than the desired position and the magnetic circuit 7 to protrude out of the frame. Accordingly, other parts provided in the front of the magnetic circuit 7, such as a damper and the voice coil bobbin, can not be affected in position.

The magnet for the magnetic circuit has a polygonal outer profile and the threaded fastening position of the rear cover to the frame is arranged outside the magnet, near the middle of each side. Therefore, compared to a magnet having a circular outer profile so as not to interfere the threaded fastening position, the volume of the magnet increases as much as the angular parts of the polygon out of its inscribed circle. As a result, the driving force increases as magnetic flux increases resulting from the increase of the magnet in size. Accordingly, the driving force may be increased without increasing the outer diameter of the frame and decreasing the magnet in size, and a speaker, which is ideal for a vehicle requiring a compact one having large driving force can be provided.

What is claimed is:

1. A speaker apparatus comprising:
a frame that has a diaphragm at a front side thereof; and
a magnetic circuit that is disposed at a rear side of the frame so as to drive the diaphragm;
wherein the magnetic circuit includes a magnet having a polygonal outer profile coaxially positioned with the diaphragm.

2. The speaker apparatus according to claim 1, further comprising:
a locking wall that protrudes inside the frame so as to fix a front end of the magnetic circuit; and
a rear cover that is screw-engaged to a rear end of the frame so as to fix a rear end of the magnetic circuit,
wherein the magnetic circuit is interposed between the rear cover and the locking wall; and
the rear cover and the frame are screw-engaged at a position in a circumference of the magnet, the position disposed in the vicinity of center of a side of the a polygon of the magnet.

3. The speaker apparatus according to claim 2,
wherein the magnet includes a hexagonal outer profile.

4. The speaker apparatus according to claim 1,
wherein the frame includes a rear end and a locking portion that is mounted inside the frame;
the magnetic circuit is interposed between the rear end and the locking portion;
the frame includes a plurality of arms each radially extending from the rear end toward a front direction of the frame such that the plurality of arms surround the magnet; and
each of the arms is positioned in the vicinity of the center of a side of a polygon of the magnet.

5. The speaker apparatus according to claim 4,
wherein the magnet includes a pentagonal outer profile.
